(19) United States
(12) Patent Application Publication
(10) Pub. No.: US 2021/0111665 A1
(43) Pub. Date: Apr. 15, 2021

(54) ASSEMBLY, MOUNTING SYSTEM AND METHOD FOR INSTALLING SOLAR PANELS ON A BASE

(71) Applicant: DURSOL B.V., Moergestel (NL)

(72) Inventor: Jan Clemens Antonius VAN DE SANDE, Moergestel (NL)

(73) Assignee: DURSOL B.V., Moergestel (NL)

(21) Appl. No.: 16/608,379

(22) PCT Filed: Apr. 25, 2018
(86) PCT No.: PCT/NL2018/050266

§ 371 Date: Oct. 25, 2019

(30) Foreign Application Priority Data
Apr. 26, 2017 (NL) 2018791

(51) Int. Cl. H02S 30/20; H02S 30/10

(52) U.S. Cl. CPC H02S 30/20; H02S 20/24; H02S 30/10

(57) ABSTRACT

The invention relates to an assembly for installing solar panels on a base, and in particular a substantially flat base, comprising at least two solar panels and a mounting system for coupling the solar panels to one another, wherein the solar panels, in a position in which they are installed on the base, enclose an angle with respect to one another. The invention also relates to a mounting system comprising a connecting element which can be subjected to compressive loads, for connecting sides of two solar panels which face one another in the installed position and a connecting element which can be subjected to tensile loads, for limiting the angle enclosed by the solar panels with respect to one another. The invention additionally relates to a method for installing solar panels on a base, and in particular a substantially flat base, by means of an assembly according to the invention.

The invention relates to an assembly for installing solar panels on a base, and in particular a substantially flat base, comprising at least two solar panels and a mounting system for coupling the solar panels to one another. The invention also relates to a mounting system for use with an assembly according to the invention. In addition, the invention relates to a connecting element which can be subjected to compressive loads, for use with a mounting system according to the invention, and solar panels provided with a mounting system according to the invention. Finally, the invention relates to a method for installing solar panels on a base, and in particular a substantially flat base, by means of an assembly according to the invention.

In the context of sustainable energy generation, the use of solar panels is subject to enormous growth. Partly thanks to this growth, the price of solar panels is decreasing, as a result of which installing solar panels is becoming increasingly interesting not only in terms of sustainability but also from a cost point of view. This reduction in costs is also changing the installation model of the solar panels. Whereas the output achieved by the (relatively expensive) solar panels was previously a decisive factor in the orientation of the solar panels, given the current fall in prices, the surface area available for installation also plays a significant role. Currently, in order to achieve a maximum yield per euro for a certain available surface area, maximizing the installed surface area of solar panels is usually the most effective option. When installing on a flat base, such as a flat roof, an east-west arrangement of the panels usually leads to the greatest installation density. This is because, in a south-facing arrangement, which is most interesting purely in terms of the output of the solar panels, a certain distance needs to be kept between successive rows of panels. This is due to the shadow which a row of panels casts on a row of panels situated behind. Choosing an east-west arrangement is therefore increasing in popularity.

Another consequence of the price reduction of solar panels is the relative increase in the costs for installation of the solar panels on a base suitable for this purpose. In this case, labor costs in particular make up a growing cost component in the total costs for installing the solar panels. It is therefore becoming increasingly interesting to reduce the labor costs when installing solar panels. However, known installation methods are relatively labor-intensive. For instance, the installation of the solar panels in known installation methods usually precedes mounting a vertical elevation on the base, on which the solar panels can be arranged. However, the construction of such a vertical elevation requires a considerable amount of time, not only due to the often complex construction of the vertical elevation, but also because the vertical elevation is usually constructed at the installation site of the solar panels. The installation site, which is not uncommonly a site which is difficult to access, such as a roof of a building, generally hinders a fast construction of the vertical elevation as well as the subsequent installation of the solar panels.

It is therefore an object of the invention to facilitate and/or simplify the installation of solar panels on a base intended for this purpose, or at least to offer an alternative to existing mounting systems and methods.

To this end, the invention provides an assembly for installing solar panels on a base, and in particular a substantially flat base, comprising: at least two solar panels, each solar panel comprising an energy-converting layer and a protective rigid top layer; and a mounting system for coupling the solar panels to one another, wherein the solar panels, in a position in which they are installed on the base, enclose an angle with respect to one another, comprising: a connecting element which can be subjected to compressive loads, for connecting sides of the solar panels which face one another in the installed position, wherein the connecting element which can be subjected to compressive loads comprises two segments, wherein each of the segments is provided with: a first supporting surface for engaging with a side of a solar panel at least at the location of the rigid top layer, and a second supporting surface facing away from the first supporting surface, for resting against the second supporting surface of the other segment; a connecting element which can be subjected to tensile loads, for limiting the angle enclosed by the solar panels with respect to one another, wherein the connecting element which can be subjected to tensile loads connects the sides of the solar panels which face away from one another in the installed position.

Within the context of the present invention, “solar panel” should be understood to mean a panel which converts solar energy into another form of energy. In a typical case, a solar panel is formed by a photovoltaic panel provided with a plurality of photovoltaic cells, which convert solar energy into electricity. However, other panels which convert solar energy, such as solar collectors, should also be classified under the term “solar panel”. A solar panel is usually a level and flat panel, via an upper side of which the energy-converting layer can be illuminated. The rigid top layer of the solar panels is in such a case formed by a glass plate. Furthermore, a solar panel usually has a rectangular or square peripheral edge, formed by four sides and usually provided with edge protection. Moreover, it should be noted that the assembly may comprise a plurality of connecting elements which can be subjected to tensile and compressive loads, in order to be able to distribute the forces over the plurality of connecting elements. The assembly may additionally comprise more than two solar panels, which in that case are generally connected by means of a plurality of connecting elements which can be subjected to tensile and compressive loads.

By coupling the solar panels to one another in such a way that the solar panels, in a position in which they are installed on the base, enclose an angle with respect to one another, an east-west arrangement of the solar panels coupled to one another is possible on a substantially flat base. To this end, the solar panels—viewed in a position of the solar panels in which they are installed on the base—must slope from the sides facing one another between the panels to the sides facing away from one another between the panels, wherein the solar panels enclose an angle with the base which is usually less than 30 degrees, preferably less than 20 degrees and more preferably approximately 10 degrees. The connecting element which can be subjected to tensile loads of the mounting system in this case serves to limit the angle enclosed between each of the solar panels and the base and thus the angle enclosed by the solar panels with respect to one another. In a typical case, the connecting element which can be subjected to tensile loads to this end connects the sides of the solar panels which face away from one another in the installed position, for which reason the connecting element which can be subjected to tensile loads usually extends between said sides. The connecting element which can be subjected to compressive loads of the mounting system serves to connect the sides of the solar panels which face one another in the installed position and keep them at a distance from one another. By allowing the first supporting surface of the segments of the connecting element which can be subjected to compressive loads to engage at least at the location of the rigid top layer with the sides of the solar panels which face one another in the installed position, the compressive force, which is introduced into the connecting element which can be subjected to compressive loads at least by the weight of the solar panels in the installed position of the assembly, is transmitted directly to the rigid top layer of the solar panels. As a result of the fact that the rigid top layers of the solar panels are situated in line with the first supporting surfaces, no moment of force is introduced into the solar panels in this case, but the rigid top layer (which is usually highly suited to being subjected to compressive loads) is solely subjected to a compressive load. With the assembly according to the invention, it is thus possible to make optimum use of the inherent strength of the structure of the solar panels. As a result of this, solar panels can be installed on a base using a minimum number of parts and a minimum amount of material. Using a minimum amount of parts for the mounting system not only makes the assembly according to the invention cost-effective to produce, but also means that the assembly can be installed on a base in a very simple manner and using a minimum number of operations, which also leads to a saving in terms of labor costs.

In a typical case, the second supporting surfaces, in a position in which the assembly is installed on the base, loosely bear against one another. The segments of the connecting element which can be subjected to compressive loads are usually separate elements which are otherwise not fixedly connected to one another or movably connected to one another. By using the second supporting surfaces which, in a position in which the assembly is installed on the base, bear loosely against one another, it is possible for the segments of the connecting element which can be subjected to compressive loads to move with respect to one another, and in particular to rotate with respect to one another. In the event that the solar panels, for example under the influence of an external load or due to (thermal) expansion or contraction, rotate with respect to one another in the installed position, thus changing the angle enclosed by the panels with respect to one another, the second supporting surfaces will assume a new position with respect to one another, meaning that the second supporting surfaces bearing loosely against one another can therefore be considered to be self-aligning. The advantage of this method of connection is that only compressive forces can be transmitted between the second supporting surfaces bearing loosely against one another, but that no transfer of moment is possible via this connection, as a result of which the solar panels are only subjected to compressive loads, and no bending moment is introduced into the solar panels if they rotate with respect to one another in the installed position. This is in contrast to a situation in which the second supporting surfaces not only rest against one another but are also fixedly connected to one another, wherein a rotation of the solar panels with respect to one another leads to the introduction of a bending moment in both the solar panels and the connecting element which can be subjected to compressive loads.

In an advantageous embodiment of the assembly according to the invention, the second supporting surfaces of the segments, upon engagement of the connecting element which can be subjected to compressive loads with the sides of the solar panels which face one another in the installed position, are situated at least in line with the rigid top layers of the solar panels. Due to the first and second supporting surfaces which are situated in line with the rigid top layer of the solar panels, no bending moment is introduced into the segments when the compressive force is transmitted from the first supporting surfaces to the second supporting surfaces at the location of the second supporting surfaces. It is also advantageous if the first supporting surface and the second supporting surface of each of the segments are connected to one another by a connecting structure which, in the installed position of the assembly, is situated in line with the rigid top layer of the solar panel with which the relevant segment engages. In this way, it is possible to entirely prevent the compressive forces transmitted by the solar panels to the connecting element which can be subjected to compressive loads from introducing a bending moment into the segments.

In another embodiment of the assembly according to the invention, the segments are connected to one another via a hinge, in such a way that the hinge is situated at a distance from the second supporting surfaces. By means of the hinge, it is possible to connect the segments to one another in such a way that they are rotatable with respect to one another. In the event that the segments are connected to the solar panels, it is therefore possible to rotate the solar panels with respect to one another in the coupled position. As a result, the solar panels can be folded, for example into a position in which the solar panels are situated substantially parallel to one another. In such a position, the assembly takes up a minimal amount of space, meaning that the assembly can be transported simply and efficiently. Once at the installation site, the assembly can then be unfolded again into an orientation of the solar panels suitable for installation. As the hinge is situated at a distance from the second supporting surfaces, the transmission of forces between the segments of the connecting element which can be subjected to compressive loads does not take place (entirely) via the hinge. The hinge can therefore be of a light-weight configuration.

It is advantageous if the hinge is flexibly connected to the supporting surfaces. The flexible connection can be realized by using an elastically deformable connecting piece which connects the supporting surfaces to the hinge. The desired flexibility may be achieved, for example, by varying the wall thickness of said connecting piece, wherein a smaller wall thickness results in a more flexible connecting piece. In a possible embodiment of the hinge, the segments may engage with a common rotation shaft, extending parallel to the first supporting surface of the segments, via a hinge leaf, wherein the hinge leaf is elastically deformable for at least a part. An advantage of flexibly connecting the hinge to the supporting surfaces is that the transmission of forces in the connecting element which can be subjected to compressive loads substantially takes place only via the second supporting surfaces. As the second supporting surfaces, in a typical case, further bear loosely against one another, the segments of the connecting element which can be subjected to compressive loads can also freely rotate with respect to one another to a certain degree in the installed position of the assembly, wherein the flexible connection to the hinge does not produce any counterforce. By using the flexible connection, the segments are therefore self-aligning. As a result, no bending moment will be introduced into the solar panels if the solar panels, for example under the influence of an external load or due to (thermal) expansion or contraction, rotate with respect to one another in the installed position, thus changing the angle enclosed by the panels with respect to one another. In order to allow the second supporting surfaces to adequately adjoin one another even with a varying mutual orientation of the segments, the segments may be designed in such a way that the contact surface of the second supporting surfaces is sufficiently large at different orientations. In a possible embodiment, the second supporting surfaces may to this end have a rounded form.

In yet another variant embodiment of the assembly according to the invention, the mounting system comprises at least two feet for supporting the solar panels on the base, wherein each of the feet is configured to engage with another of the sides of the solar panels which face away from one another in the installed position. By allowing the solar panels to rest on the base via the feet, a larger contact surface with the base can be brought about, which results in an improved support of the assembly on the base. In an advantageous case, the feet engage with a side of a solar panel at least at the location of the rigid top layer. The compressive forces present in the rigid top layer can thus be transmitted directly to the feet, as a result of which bending moments in the solar panels are prevented. Each of the feet may also adjoin substantially the entire side of a solar panel, as a result of which the forces transmitted to the feet are distributed over substantially the entire side of the relevant solar panel. The formation of force concentrations in the panels at the location of the supporting points is thus prevented.

It is possible for at least one foot to be provided with a coupling for engaging with the connecting element which can be subjected to tensile loads. For this purpose, the coupling may be of varying form, and may for example be formed by a retention element, a hole provided in the foot, or fastening means of all kinds. In an advantageous case, each of a pair of opposite feet are provided with such a coupling. By allowing the connecting element which can be subjected to tensile loads to engage with the feet, the load on the solar panels can be at least partially reduced. If the feet engage with a side of a solar panel at the location of the rigid top layer, it is also possible to ensure that the solar panels, and in particular the rigid top layers thereof, are substantially only subjected to compressive loads.

In order to ensure adequate fixing of the assembly to the base, it is also possible for at least one foot to be able to be coupled to the base. An additional advantage of coupling at least one foot to the base is that the assembly, under the influence of the wind or another, external force, detaches from the base or shifts with respect to the base. Here, too, the coupling may be implemented in various ways. In a possible embodiment, the foot is provided with a through-hole for passing through fastening means, such as a screw or a bolt, by means of which the foot can be fastened to the base. Apart from coupling to the base, at least one foot can be coupleable to an adjacent foot. An assembly comprising a plurality of solar panels can thus be fastened to one another by means of the feet. The solar panels may be coupled in both the longitudinal direction and the transverse direction, as a result of which coupled rows of solar panels arranged one behind the other or arranged next to one another can be formed. In a possible embodiment of the coupling, adjacent feet may be equipped with a cutout through which a fastening element can be passed in order to couple the feet to one another. It is also possible for two adjacent feet to be provided with complementary fastening elements. In addition, it is conceivable for a foot to engage with a plurality of, and in particular two adjacent panels, wherein the foot forms the connecting element which couples the adjacent panels to one another.

In yet another embodiment of the assembly according to the invention, the feet are integrally connected to the sides of the solar panels which face away from one another in the installed position. By means of an integral connection of the feet to the sides of the solar panels which face away from one another in the installed position, a stronger connection between the sides and the feet can be brought about. In addition, an integral connection lends itself in particular to providing the assembly in the coupled position ex works, which then merely needs to be installed on the base at the place of installation. For the same reasons, the at least one connecting element which can be subjected to compressive loads may be integrally connected to the sides of the solar panels which face one another in the installed position.

It is also possible for the length of the feet to be substantially equal to the length of the sides of the solar panels which face away from one another in the installed position. With the feet engaging with the sides of the solar panels which face away from one another in the installed position, the feet thus extend over substantially the entire length of said sides which face away from one another. By allowing the length of the feet to correspond to the length of the sides of the solar panels which face away from one another in the installed position, forces in the solar panels can be transmitted to the feet over the entire length of the sides. This leads to a more homogeneous distribution of the forces over the structure, as a result of which force concentrations and thus the associated formation of cracks in or other failures of the structure can be prevented. For the same reasons, the length of the connecting element which can be subjected to compressive loads is chosen to be substantially equal to the length of the sides of the solar panels which face one another in the installed position. In this case, the connecting element which can be subjected to compressive loads extends, upon engagement of the sides of the solar panels which face one another in the installed position, over substantially the entire length of said sides which face one another.

In such a case, the connecting element which can be subjected to tensile loads is formed by a tensioning cable. The tensioning cable may in this case be made from a metal, and in particular (an alloy of) a stainless steel. However, it is also possible for the tensioning cable to be made from synthetic fibers such as dyneema, kevlar, nylon, aramid or a combination thereof in order to provide the cable with the required tensile strength. The advantage of a tensioning cable is that it generally can only be subjected to tensile loads, as a result of which the connecting element which can be subjected to tensile loads can remain coupled to the assembly when the sides of the solar panels which face away from one another in the installed position are moved toward one another during folding. If it is not necessary to fold the assembly or it is preferred to connect the connecting element which can be subjected to tensile loads at the installation site of the assembly, wherein the solar panels are already installed in the unfolded position, it is then likewise possible to use an element such as a tie rod or profiled beam, which can also be subjected to compressive loads, for the connecting element which can be subjected to tensile loads.

In a possible embodiment of the assembly according to the invention, the segments are each provided with a guide element for engaging with the guide element of the other segment, wherein the guide element is configured, upon engagement by the guide element of the other segment, to align the segments with one another in such a way that the second supporting surfaces rest on one another in the installed position of the solar panels. The guide elements thus contribute toward mutually orienting the solar panels in such a way that the second supporting surfaces of the segments of the connecting element which can be subjected to compressive loads engage with one another. This facilitates the mutual positioning of the solar panels and thus accelerates the installation process. In such a case, the guide elements are formed by complementary, self-aligning brackets which, upon sliding two solar panels which are stacked on one another and already provided with the segments away from one another, engage with one another in a preferred orientation.

In order to support the assembly centrally, the connecting element which can be subjected to compressive loads may be provided with at least one leg for resting on the base. Such a leg may guide an external load (such as for example snow), which exerts a downward force on the assembly installed on the base, directly into the base. As a result, the solar panels and the connecting element which can be subjected to tensile loads are not subjected to any additional loads, which could lead to failure of the structure. By using the above-mentioned leg, which transmits at least some of the forces acting on the assembly, it is also possible to make the connecting element which can be subjected to tensile loads more light-weight.

In order to prevent the assembly detaching from the base under the influence of the wind or another, external force acting in an upward direction, the mounting system may be provided with ballast for exerting a downward force on the connecting element which can be subjected to compressive loads. In such a case, the ballast may be fastened to the assembly in a central position, for example using a retention element which is suitable for the purpose. It is also possible for the ballast to be integrated into a part of the assembly, such as into a central part of the connecting element which can be subjected to compressive loads.

Another way in which it is possible to prevent the assembly detaching from the base under the influence of the wind is by providing the connecting element which can be subjected to compressive loads with a windbreak which protrudes above the tops of the solar panels in the installed position of the assembly. As the solar panels enclose an angle with respect to one another in the installed position, in the event of an air flow flowing from one solar panel in the direction of the other solar panel on the top of the solar panels, an underpressure may arise at the location of the solar panel which slopes downward seen in the direction of flow of the air flow. As a result of this underpressure, the assembly may possibly be lifted from the base. Said windbreak may locally disrupt the air flow in order to counteract the formation of this underpressure. For the best operation, the windbreak can be arranged at the location of the transition between the solar panels. In this case, it is possible for the windbreak to be provided with the connecting element which can be subjected to compressive loads on a top defined in the installed position. For this purpose, the windbreak may be connected fixedly or detachably to the connecting element which can be subjected to compressive loads. The windbreak may also be configured as a substantially closed surface, but may also comprise a partly open structure.

The invention also relates to a mounting system for use with an assembly according to the invention, which mounting system is configured for coupling the solar panels to one another, wherein the solar panels, in a position in which they are installed on the base, enclose an angle with respect to one another. For this purpose, the mounting system comprises a connecting element which can be subjected to tensile loads, for limiting the angle enclosed by the solar panels with respect to one another, and a connecting element which can be subjected to compressive loads, for connecting sides of the solar panels which face one another in the installed position, wherein the connecting element which can be subjected to compressive loads comprises two segments, wherein each of the segments is provided with: a first supporting surface for engaging with a side of a solar panel at least at the location of the rigid top layer, and a second supporting surface facing away from the first supporting surface, for resting against the second supporting surface of the other segment. The advantages of such a mounting system have been described above. The mounting system may already be connected to the at least two solar panels before installing the solar panels on the base and transported as an assembly with the at least two solar panels. It is also possible for the mounting system to already be connected to the solar panels during or directly after manufacture of the solar panels in order to thus form the above-described assembly.

The invention also relates to a connecting element which can be subjected to compressive loads for use with a mounting system according to the invention.

Finally, the invention relates to a method for installing solar panels on a base, and in particular a substantially flat base, by means of an assembly according to the invention, comprising the steps of: A) transporting the at least two solar panels in a stacked position, wherein the solar panels are situated substantially parallel to one another, B) unfolding the solar panels before installation on the base, wherein the solar panels are situated substantially in line with one another and wherein the solar panels enclose an angle with the base, which angle is usually less than 30 degrees, preferably less than 20 degrees and more preferably approximately 10 degrees, and C) installing the assembly on the base in the unfolded position of the solar panels. By transporting the solar panels in the stacked position, the assembly takes up a minimal amount of space during transport. Once at the site where the assembly needs to be installed on the base, the solar panels may be simply unfolded. For an east-west arrangement of the solar panels, it has been found that a maximum efficiency of the solar panels is achieved if the solar panels enclose an angle with the base which is less than 30 degrees, preferably less than 20 degrees and more preferably around 10 degrees.

In a possible embodiment of the method according to the embodiment, the method may also comprise step D), comprising fastening the assembly to the base after installing the assembly on the base in the unfolded position of the solar panels. It is also possible for the mounting system to be attached to the solar panels before transporting the solar panels. The mounting system may already be attached to the solar panels during or directly after manufacture of the solar panels, considerably simplifying the installation process of the assembly.

The invention will be explained by means of non-limiting exemplary embodiments which are illustrated in the following figures. Corresponding elements are denoted in the figures by corresponding reference numerals. In the figures:

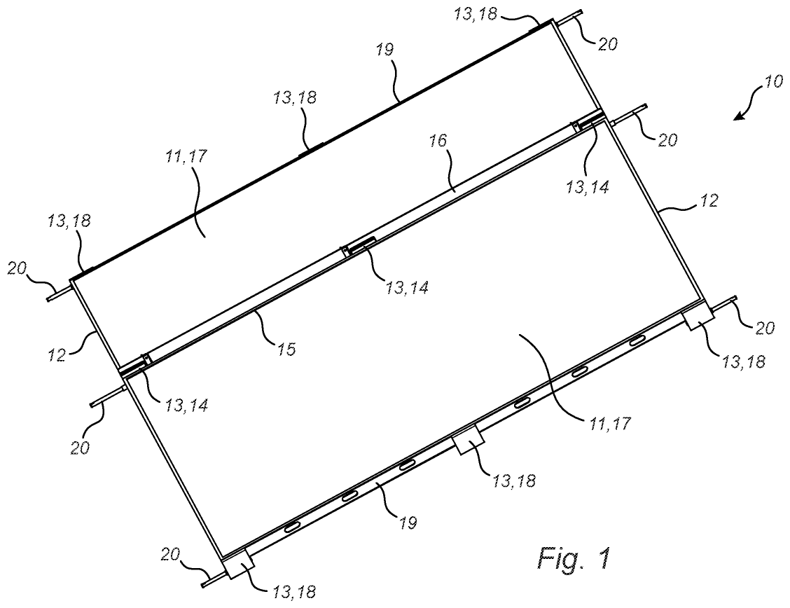

FIG. 1 shows a perspective view of an assembly according to the invention in an unfolded position in which it can be installed on the base,

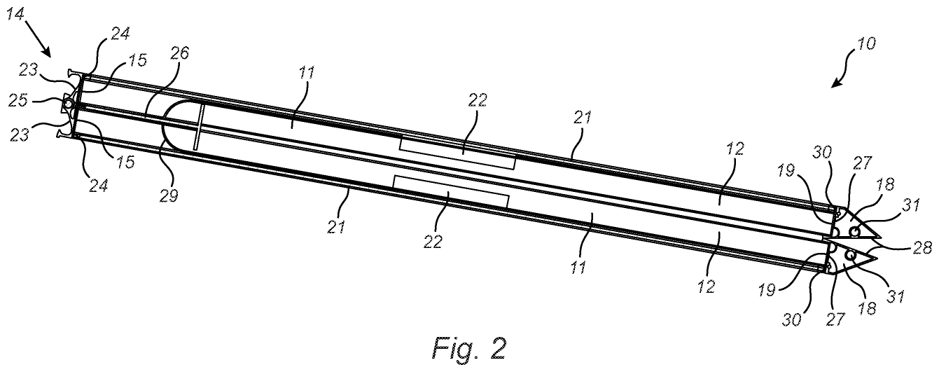

FIG. 2 shows a side view of the assembly as shown in FIG. 1 in a folded position suitable for transport,

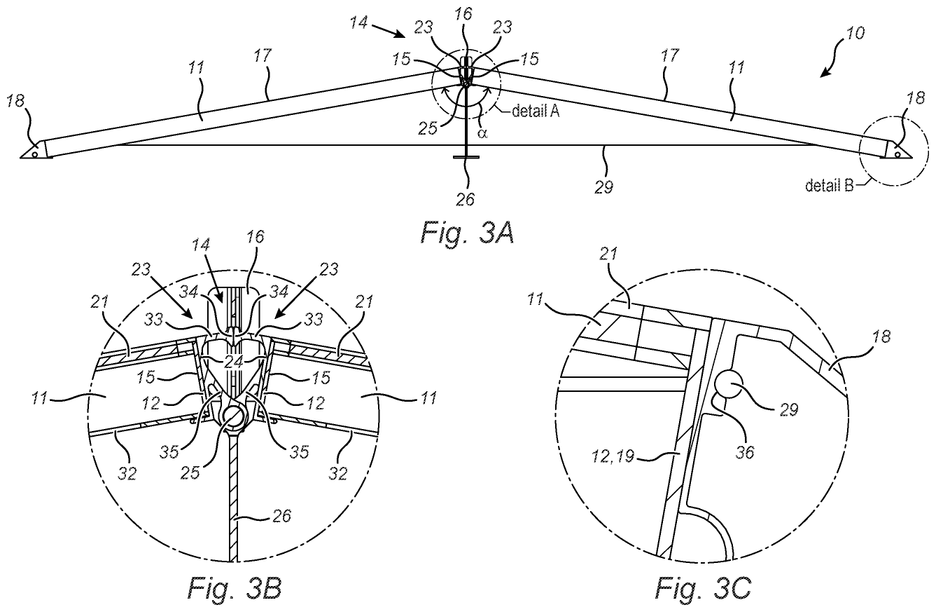

FIG. 3A shows a side view of the assembly in a position in which it can be installed on the ground, as shown in FIG. 1,

FIG. 3B shows a detail view of the detail indicated in FIG. 3A by “detail A”,

FIG. 3C shows a detail view of the detail indicated in FIG. 3A by “detail B”,

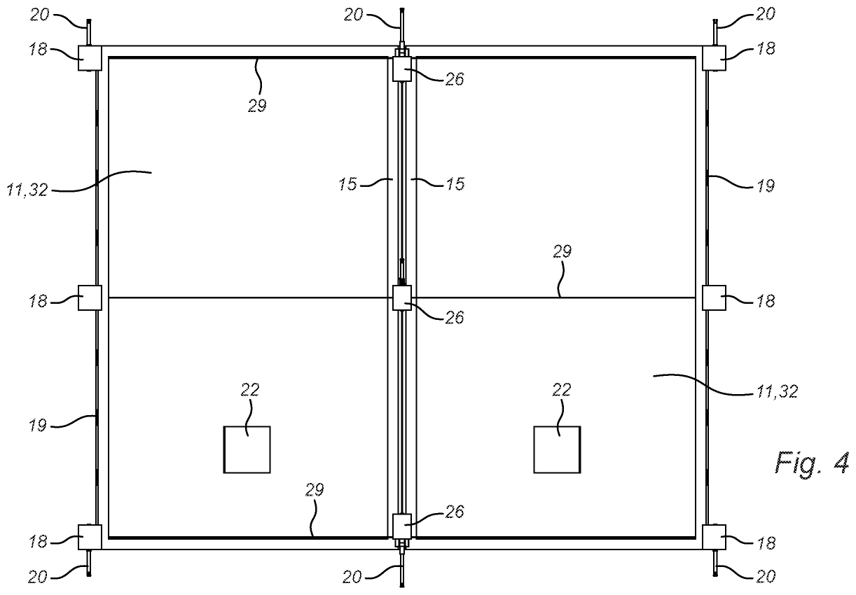

FIG. 4 shows a bottom view of the assembly in a position in which it can be installed on the ground, as shown in FIG. 1,

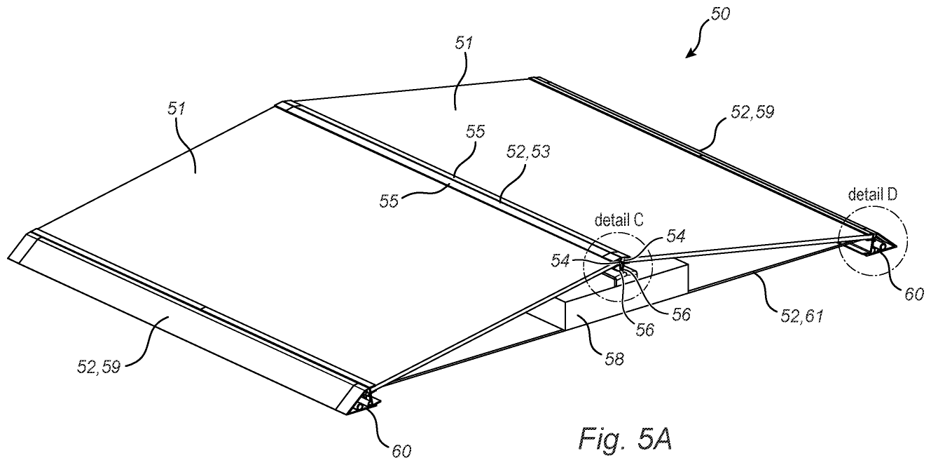

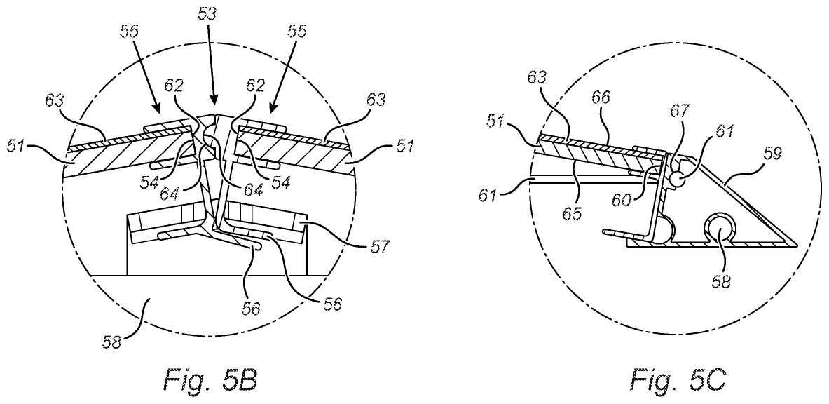

FIG. 5A shows a perspective view of an alternative embodiment of an assembly according to the invention in an unfolded position in which it can be installed on the base,

FIG. 5B shows a detail view of the detail indicated in FIG. 5A by “detail C”, and

FIG. 5C shows a detail view of the detail indicated in FIG. 5A by “detail D”.

FIG. 1 shows a perspective view of an assembly 10 according to the invention in an unfolded position in which it can be installed on the base. The assembly 10 comprises two solar panels 11, which are surrounded at the side by a frame 12. The assembly 10 also comprises a mounting system 13, by means of which the solar panels 11 are coupled to one another. In the embodiment shown, the mounting system 13 comprises three connecting elements 14 which can be subjected to compressive loads and which connect the sides 15 of the solar panels 11 which face one another in the installed position illustrated and keep them at a distance from one another. On the top of the connecting elements 14 which can be subjected to compressive loads, a windbreak 16 is arranged which protrudes above the tops 17 of the solar panels 11. The mounting system 13 also comprises six feet 18 arranged on either side of the assembly 10, by means of which the solar panels 11 can rest on the base. In this case, the feet 18 engage with the sides 19 of the solar panels 11 which face away from one another in the installed position illustrated. The outer feet 18 are also provided with pins 20 which form fastening elements, by means of which these feet 18 can be coupled to an adjacent foot in order to form a row of consecutive solar panels 11.

FIG. 2 shows a side view of the assembly 10 as shown in FIG. 1 in a folded position suitable for transport. In the position shown, the solar panels 11 are situated substantially parallel to one another, wherein the protective rigid top layers 21—usually formed by a glass plate—are facing outward. The solar panels 11 are protected at a peripheral edge by the frame 12 and are provided at the bottom with an electrical junction box 22. The connecting element 14 which can be subjected to compressive loads connects the sides 15 of the solar panels 11 which face one another in the installed position. To this end, the connecting element 14 which can be subjected to compressive loads comprises two segments 23, each provided with a first supporting surface 24, by means of which they engage with the sides 15 of the solar panels 11 at least at the location of the rigid top layer 21. The segments 23 are connected to one another by means of a hinge 25 situated centrally between the segments 23. The hinge 25 also forms a point of engagement for a leg 26 situated between the solar panels 11 in the folded position, by means of which the assembly 10 can additionally rest on the base. On the sides 19 of the solar panels 11 which face away from one another in the installed position, feet 18 are provided which engage with the sides 19 via a first surface 27 at least at the location of the rigid top layer 21. Via a second surface 28, the foot 18, and thus the assembly 10, can rest on the base. The feet 18 are connected to one another via a connecting element 29 which can be subjected to tensile loads, for which purpose the ends 30 of the connecting element 29 which can be subjected to tensile loads engage with the feet 18. In the embodiment shown, the connecting element 29 which can be subjected to tensile loads is formed by a tensioning cable, which is situated between the solar panels 11 in the folded position of the assembly 10. The feet 18 are also provided with through-holes 31 for passing through the pins 20 shown in FIG. 1.

FIG. 3A shows a side view of the assembly 10 in a position in which it can be installed on the ground, as shown in FIG. 1. The connecting element 29 which can be subjected to tensile loads connects the feet 18 which engage with either side of the assembly 10, as a result of which the angle α enclosed by the solar panels 11 with respect to one another is limited. The connecting element 14 which can be subjected to compressive loads and which is clamped between the sides 15 of solar panels 11 which face one another keeps the solar panels 11 at a distance from one another at a top. It can once again be seen that the segments 23 of the connecting element 14 which can be subjected to compressive loads are connected to one another by means of a hinge 25 situated centrally between the segments 23. The leg 26 extends downward from the hinge 25 until the base or just above the base, in order to support the assembly 10 centrally or support it in the event of an additional load on the solar panels 11. The windbreak 16 arranged on the connecting element 14 which can be subjected to compressive loads protrudes above the tops 17 of the solar panels 11.

FIG. 3B shows a detail view of the detail, indicated in FIG. 3A by “detail A”, of the assembly 10 at the location of the connecting element 14 which can be subjected to compressive loads. The connecting element 14 which can be subjected to compressive loads comprises two segments 23, each provided with a first supporting surface 24 which bears against the entire side 15 of the solar panel and thus also engages with the side 15 at the location of the rigid top layer 21. In the illustrated case, the sides 15, 19 of the solar panels 11 are formed by a frame 12 provided on the peripheral edge of the solar panels. However, it is also conceivable for the solar panels 11 not to be provided with such a framing, in which case the first supporting surfaces 24 bear directly against the sides 15 of the solar panels 11. In addition, the first supporting surfaces 24 also engage with the bottom 32 of the solar panels 11, by means of which the solar panels 11 are supported at the ends facing one another. However, it is also possible for the first supporting surfaces 24 to engage with the sides 15 of the solar panels 11 only at the location of the rigid top layer 21. The first supporting surface 24 of each of the segments 23 is connected to a second supporting surface 34 of the same segment 23 by means of a connecting structure 33, wherein the connecting structure 33 is situated in line with the rigid top layer 21 of the solar panel 11 with which the first supporting surface 24 engages. As a result, the second supporting surface 34 of each of the segments 23 is situated in line with the rigid top layer 21 of the solar panel 11. The second supporting surfaces 34 are also rounded so that the surface on which the second supporting surfaces 34 engage with one another is sufficiently large at different orientations of the second supporting surfaces 34. The hinge 25 which connects the segments 23 of the connecting element 14 which can be subjected to compressive loads to one another is situated at a distance from and directly below the second supporting surfaces 34. The hinge 25 is also situated at a distance from the first supporting surfaces 24 and is flexibly connected to the supporting surfaces 24, 34. The flexible connection is formed by an elastically deformable connecting piece 35 which, in such a case, only has a limited wall thickness. Finally, the leg 26 and the windbreak 16 are visible and engage with a bottom and a top, respectively, of the connecting element 14 which can be subjected to compressive loads.

FIG. 3C shows a detail view of the detail, indicated in FIG. 3A by “detail B”, of the assembly 10 at the location where a foot 18 engages with the solar panel 11 and the connecting element 29 which can be subjected to tensile loads engages with the foot 18. The foot 18 engages with the side 19 (bordered by the frame 12) of the solar panel 11. More specifically, the foot 18 engages with the solar panel 11 at the location of the rigid top layer 21. The same applies to the connecting element 29 which can be subjected to tensile loads and which engages with the foot 18 at the location of the rigid top layer 21 or directly below. A coupling 36 is provided on the foot 18 for engaging with the connecting element 29 which can be subjected to tensile loads. In the embodiment shown, the coupling 36 is formed by a cutout in which the connecting element 29 which can be subjected to tensile loads is accommodated.

FIG. 4 shows a bottom view of the assembly 10 in a position in which it can be installed on the ground, as shown in FIG. 1. The feet 18 and the legs 26, by means of which the assembly 10 can rest on the base, are clearly visible. Also visible are the pins 20 which are provided on the outer feet 18 for coupling to an adjacent foot. The connecting elements 14 which can be subjected to compressive loads may also be provided with such pins 20 for coupling to an adjacent connecting element 14 which can be subjected to compressive loads.

FIG. 5A shows a perspective view of an alternative embodiment of an assembly 50 according to the invention in an unfolded position in which it can be installed on the base. The assembly 50 shown in this figure, like the assembly shown in the preceding figures, comprises two solar panels 51 and a mounting system 52, by means of which the solar panels 51 are coupled to one another. In the embodiment shown, the mounting system 52 comprises a single connecting element 53 which can be subjected to compressive loads and which extends over substantially the entire length of the sides 54 of the solar panels 51 which face one another in the position shown. The segments 55 of the connecting element 53 which can be subjected to compressive loads are additionally each provided with a guide element 56 for engaging with the guide element 56 of the other segment 55. The guide elements 56 also serve as engagement element for engagement by a bracket 57 (see FIG. 5B) from which ballast 58 is suspended. The mounting system 52 further comprises two feet 59 which extend on either side of the assembly 50 over substantially the entire length of the sides 60 of the solar panels 51 which face away from one another in the position shown. The feet 59 are connected to one another via a connecting element 61 which can be subjected to tensile loads, which connecting element 61 which can be subjected to tensile loads is formed in the present case by a tensioning cable.

FIG. 5B shows a detail view of the detail, indicated in FIG. 5A by “detail C”, at the location of the connecting element 53 which can be subjected to compressive loads. In the illustrated embodiment, the connecting element 53 which can be subjected to compressive loads once again comprises two segments 55. The segments 55 engage with the side 54 of a solar panel 51 via a first supporting surface 62, wherein they also rest against the side 54 of the solar panel 51 at the location of the rigid top layer 63 of the solar panel 51. The segments 55 also rest via the second supporting surface 64 against the second supporting surface 64 of the other segment 55, by means of which the sides 54 of the solar panels 51 which face one another in the position shown are connected to one another. The segments 55 are also provided with guide elements 56, formed by complementary, self-aligning profiles which, upon sliding two solar panels 51 which are stacked on one another and already provided with the segments 55 away from one another, engage with one another in a preferred orientation. The guide elements 56 additionally serve as engagement element for engagement by a bracket 57 from which ballast 58 is suspended.

Finally, FIG. 5C shows a detail view of the detail, indicated in FIG. 5A by “detail D”, of the assembly 50 at the location where a foot 59 engages with the solar panel 51 and the connecting element 61 which can be subjected to tensile loads engages with the foot 59. In the embodiment shown, the foot 59 engages with the bottom 65 and top 66 and with the entire side 60 of the solar panel 51, wherein the foot 59 also rests against the side 60 of the solar panel 51 at the location of the rigid top layer 63 of the solar panel 51. A coupling 67 is once again provided on the foot 59 for engaging with the connecting element 61 which can be subjected to tensile loads. Due to the specific placement of the coupling 67, the connecting element 61 which can be subjected to tensile loads engages with the foot 59 at the location of the rigid top layer 63 or directly below. The foot 59 is also provided with a through-hole 68 for passing through a pin, by means of which a coupling to the foot 59 of an adjacent assembly 50 can be brought about.

It will be clear that the invention is not limited to the exemplary embodiments illustrated and described here, but that countless variants are possible within the framework of the attached claims which will be obvious to the person skilled in the art. In this case, it is conceivable for various inventive concepts and/or technical measures of the above-described variant embodiments to be completely or partly combined without, in this case, moving away from the inventive idea described in the attached claims.

1. An assembly for installing solar panels on a base, and in particular a substantially flat base, comprising:
at least two solar panels, each solar panel comprising an energy-converting layer and a protective rigid top layer; and
a mounting system for coupling the solar panels to one another, wherein the solar panels, in a position in which they are installed on the base, enclose an angle with respect to one another, comprising:
a connecting element which can be subjected to compressive loads, for connecting sides of the solar panels which face one another in the installed position, wherein the connecting element which can be subjected to compressive loads comprises two segments, wherein each of the segments is provided with:
a first supporting surface for engaging with a side of a solar panel at least at the location of the rigid top layer, and
a second supporting surface facing away from the first supporting surface, for resting against the second supporting surface of the other segment; and
a connecting element which can be subjected to tensile loads, for limiting the angle enclosed by the solar panels with respect to one another.

2. The assembly as claimed in claim 1, wherein the second supporting surfaces, in a position in which the assembly is installed on the base, loosely bear against one another.

3. The assembly as claimed in claim 1, wherein the second supporting surfaces of the segments, upon engagement of the connecting element which can be subjected to compressive loads with the sides of the solar panels which face one another in the installed position, are situated at least in line with the rigid top layers of the solar panels.

4. The assembly as claimed in claim 1, wherein the segments are connected to one another via a hinge, in such a way that the hinge is situated at a distance from the second supporting surfaces.

5. The assembly as claimed in claim 4, wherein the hinge is flexibly connected to the supporting surfaces.

6. The assembly as claimed in claim 1, wherein the mounting system comprises at least two feet for supporting the solar panels on the base, wherein each of the feet is configured to engage with another of the sides of the solar panels which face away from one another in the installed position.

7. The assembly as claimed in claim 6, wherein at least one foot is provided with a coupling for engaging with the connecting element which can be subjected to tensile loads.

8. The assembly as claimed in claim 6, wherein at least one foot can be coupled to the base.

9. The assembly as claimed in claim 6, wherein at least one foot can be coupled to an adjacent foot.

10. The assembly as claimed in claim 6, wherein the feet are integrally connected to the sides of the solar panels which face away from one another in the installed position.

11. The assembly as claimed in claim 6, wherein the length of the feet is substantially equal to the length of the sides of the solar panels which face away from one another in the installed position.

12. The assembly as claimed in claim 1, wherein the connecting element which can be subjected to compressive loads is integrally connected to the sides of the solar panels which face one another in the installed position.

13. The assembly as claimed claim 1, wherein the length of the connecting element which can be subjected to compressive loads is substantially equal to the length of the sides of the solar panels which face one another in the installed position.

14. The assembly as claimed in claim 1, wherein the connecting element which can be subjected to tensile loads is formed by a tensioning cable.

15. The assembly as claimed in claim 1, wherein the segments are each provided with a guide element for engaging with the guide element of the other segment, wherein the guide element is configured, upon engagement by the guide element of the other segment, to align the segments with one another in such a way that the second supporting surfaces rest on one another in the installed position of the solar panels.

16. The assembly as claimed in claim 1, wherein the connecting element which can be subjected to compressive loads is provided with at least one leg for resting on the base.

17. The assembly as claimed in claim 1, wherein the mounting system is provided with ballast for exerting a downward force on the connecting element which can be subjected to compressive loads.

18. The assembly as claimed in claim 1, wherein the connecting element which can be subjected to compressive loads is provided with a windbreak which protrudes above the tops of the solar panels in the installed position of the assembly.

19. (canceled)

20. (canceled)

21. (canceled)

22. A method for installing solar panels on a base, and in particular a substantially flat base, by means of an assembly as claimed in claim 1, comprising the steps of:
A) transporting the at least two solar panels in a stacked position, wherein the solar panels are situated substantially parallel to one another,
B) unfolding the solar panels before installation on the base, wherein the solar panels are situated substantially in line with one another and wherein the solar panels enclose an angle with the base, which angle is usually less than 30 degrees, preferably less than 20 degrees and more preferably approximately 10 degrees, and
C) installing the assembly on the base in the unfolded position of the solar panels.

23. (canceled)

24. The method as claimed in claim 22, wherein the mounting system is arranged on the solar panels prior to step A).
